(19) United States
(12) Patent Application Publication
(10) Pub. No.: US 2018/0128480 A1
(43) Pub. Date: May 10, 2018

(54) THERMO-KINETIC REACTOR WITH MICRO-NUCLEAR IMPLOSIONS

(71) Applicant: Constantin Tomoiu, Ansonia, CT (US)

(72) Inventor: Constantin Tomoiu, Ansonia, CT (US)

(21) Appl. No.: 15/672,944

(22) Filed: Aug. 9, 2017

Related U.S. Application Data
(60) Provisional application No. 62/419,917, filed on Nov. 9, 2016.

(51) Int. Cl. F23C 99/00; F02M 27/08; G10K 15/04; F02M 25/022; F23L 7/00; F01K 21/04

(52) U.S. Cl. CPC F23C 99/003; F02M 27/08; F01K 21/04; F02M 25/022; F23L 7/005; G10K 15/043

(57) ABSTRACT

A thermo-kinetic process where a micro-packet of a mixture of air, fuel, and water are exposed to high energy ultrasound, a high frequency electromagnetic field, and thermal energy to initiate micro-nuclear fusion. A reaction chamber with a nozzle and adjacent resonance chamber form micro-packets and micro-explosions. The micro-explosions form high negative pressure bubbles which implode accelerating fusible elements towards a center forming a nucleus generating kinetic energy.

### RELATED APPLICATION

This application claims the benefit of U.S. Provisional Application No. 62/419,917 filed Nov. 9, 2016, which is incorporated herein by reference.

### FIELD OF THE INVENTION

The present invention relates in general to an efficient heat generator, and more particularly to a process and device implementing a momentary micro-nuclear fusion reactor or MMNFR.

### BACKGROUND OF THE INVENTION

There have been numerous efforts in the past to developed efficient energy sources. These efforts include U.S. Pat. No. 6,804,963 entitled “Thermoreactor with Linear to Rotational Motion Conversion”, issuing Oct. 19, 2004 to Tomoiu; U.S. Pat. No. 8,752,665 entitled “Thermo-Acoustic Reactor with Molecular Disassociation” issuing Jun. 17, 2014 to Tomoiu; and U.S. Pat. No. 9,454,955 entitled “Thermo-Acoustic Reactor with Non-Thermal Energy Absorption in Inert Medium” issued on Sep. 27, 2016 to Constantin Tomoiu, all of which are incorporated herein by reference.

For the past sixty years research has been conducted into controlled fusion, with the goal of producing clean energy. Extreme scientific and technical difficulty has been encounter. Currently, controlled fusion reactions have been unable to produce a self-sustaining controlled fusion reaction. Progress has been made in the design of reactors, most notably the International Thermonuclear Experimental Reactor (ITER) at the Cadarache facility in Saint-Paul-les-Durance in southern France. In 2035 ITER is expected to operate at 500 MW for at least 400 seconds continuously with less than 50 MW input power. The ITER will produce no electricity or useful energy.

National Ignition Facility (NIF) at Lawrence Livermore National Laboratory is a laser based inertial confinement fusion (ICF) research device. In an historic record-breaking laser shot, the NIF laser system of 192 beams delivered more than 500 MW of peak power and 1.85 MJ of ultraviolet laser to its (2 mm diameter) target for a few trillions of a second. It was reported that in September 2013 at NIF for the first time the amount of energy released through the fusion reaction exceeded the amount of energy being absorbed by the fuel, but not the amount supplied by the giant lasers. The publication of this in 2014 said 17 KJ was released.

While these devices have proven to be efficient, there is a need for continued improvement to obtain even greater efficiencies.

### SUMMARY OF THE INVENTION

The present invention uses a thermo-kinetic process where a micro-packet of a mixture of air, fuel, and water are exposed to high energy ultrasound, a high frequency electromagnetic field, and thermal energy to initiate micro-nuclear fusion. Microscopic packets or micro-packets of air-fuel and water are formed with water having a fuel ratio by mass of up to 16.45/1. The micro-packets may contain light fusible elements, such as deuterium and tritium. There may also be an electrically conductive fluid introduced into the micro-packets, such as salt water. Air-fuel in the micro-packets is initially ignited by an induction coil to generate micro-explosions in a reaction chamber. The micro-explosions propel with high velocity contained particles which collide with other particles in a reaction zone and with hot reactor walls. As the micro-explosions continue to expend pushing with high pressure on surrounding gases, the internal pressure of the expending micro-explosion will decrease lowering the density of contained gases caused by increasing temperature and by the high velocity particles moving outward from the center of the micro-explosion where a void or a high negative pressure bubble is formed. When the pressure of the expending micro-explosion equals the pressure of gases in the reaction chamber, then the high negative pressure bubble will violently implode and collapse generating a high pressure, high temperature plasma and a shock wave. A magnetic field is generated or induced by the plasma currents. When the high negative pressure bubble collapses heated particles in the inner boundary surface of the bubble are accelerated towards the center of the collapsing bubble to fill the void where the particles collide to form plasma. At this moment matter contained in the plasma is electrically conductive and interacts with eddy currents where the temperature and pressure are farther increased. At a high temperature and pressure gases trapped inside the bubble are compressed. The generated magnetic field, and magnetic field generated by eddy currents may confine the plasma. At the end stage of the collapsing bubble, light fusible elements inside the bubble are subject to high energy collisions. As a result of the high energy collisions, high pressure, and temperature the light fusible elements will fuse to form a heavier nucleus with the release of kinetic energy. The excess kinetic energy is stored in the degrees of freedom of a moderator light water causing its temperature to rise. The combination of a micro-explosion with the generation of a high negative pressure bubble and implosion of the bubble creates a momentary micro-nuclear fusion reactor or MMNFR.

At thermal equilibrium the temperature of the water is increased almost entirely by the micro-nuclear fusion reactions and the output thermal energy is grater then the energy released by chemical reactions for the amount of fuel used. The excess thermal energy cannot be explained by the chemical reaction of the air-fuel mixture alone or heat generated by induction and defies any explanation except in terms of micro-nuclear fusion. It is believe that a higher concentration of light fusible elements inside the imploding bubble will increase the efficiency of the process.

Accordingly, it is an object of the present invention to provide an efficient energy source.

It is an advantage of the present invention that it does not rely solely on a chemical reaction to produce energy.

It is a feature of the present invention that micro-explosions produce high pressure and temperature causing micro-nuclear fusion reaction where mass is converted to energy.

These and other objects, advantages, and features will become more readily apparent in view of the following detailed description.

### BRIEF DESCRIPTION OF THE DRAWINGS

FIG. 1 schematically illustrates an embodiment of the present invention.

FIG. 2 schematically illustrates different arrangement of micro-packet and ultrasound generator and induction coil where resonance chamber and nozzle are directly heated by eddy currents generated by the induction coil.

### DETAILED DESCRIPTION OF THE INVENTION

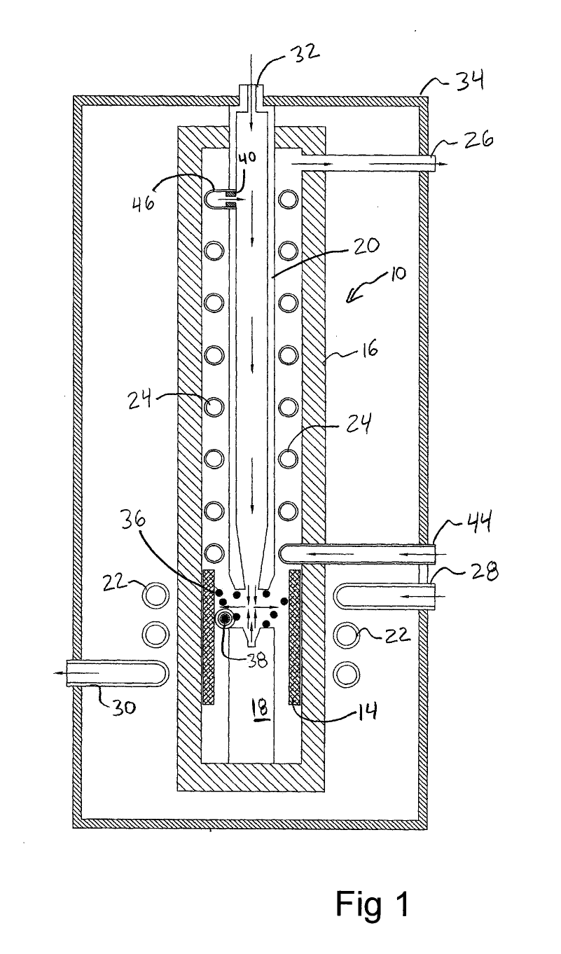

FIG. 1 schematically illustrates the thermo-kinetic reactor 10 with reaction chamber 16. Placed within reaction chamber 16 are nozzle 20 and resonance chamber 18. Resonance chamber 18 has a conic-cylindrical geometry. Iron cylinder 14 is placed within a portion of the reaction chamber 16 and is heated by high frequency alternating magnetic field generated by induction coil 22. Induction coil 22 has an input port 28 and output port 30 for water cooling. Coil 24 is placed in reaction chamber 16. Coil 24 has an input port 44 and output port 46. Outlet port 46 communicates with nozzle 20 through restriction passage 40. High pressure water steam formed in coil 24 will mix with air and fuel in nozzle 20. Nozzle 20 has an air-fuel input port 32. Reaction chamber 16 has an exhaust port 26. The thermo-kinetic reactor 10 is enclosed in a thermal insulation chamber 34.

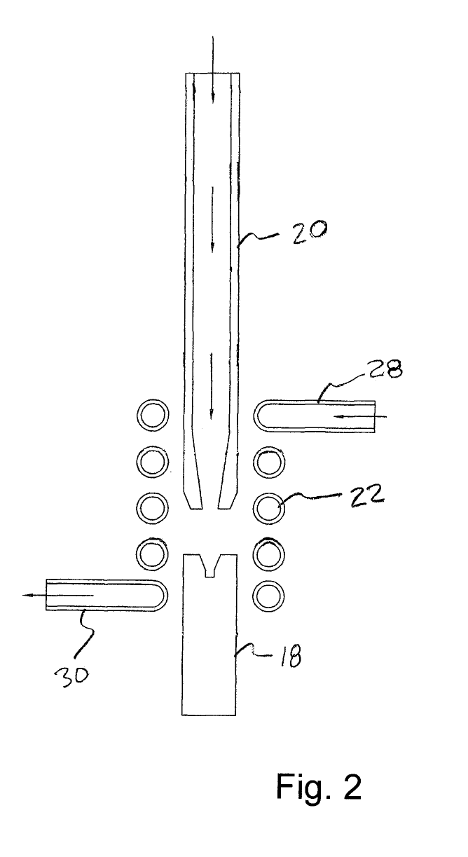

FIG. 2 schematically illustrated an embodiment of the micro-packets and ultrasound generator of the present invention with a resonance chamber 18 and nozzle 20 made of an electrically conductive material. Induction coil 22 is wrapped around resonance chamber 18 and nozzle 20. Resonance chamber 18 and nozzle 20 are heated by eddy currents generated therein by the induction coil 22. In this embodiment there is no need for the iron cylinder 14 illustrated in FIG. 1.

The operation of thermo-kinetic reactor 10 can readily be appreciated by the following description. Induction coil 22 is energized to bring iron cylinder 14 to a high temperature. Cooling water is circulated through induction coil 22. Air and fuel are input at the air and fuel inlet port 32 and directed into nozzle 20. Water is circulated in coil 24 from input port 44 to form high pressure steam. At output port 46 a restriction passage 40 causes high pressure steam to exit from coil 24 to mix with the air and fuel mixture in nozzle 20. The air, fuel, and steam mixture in nozzle 20 flows with supersonic velocity into resonance chamber 18. When the pressure in resonance chamber 18 becomes greater than the incoming pressure from nozzle 20 the air, fuel, and steam mixture flows in an opposite direction colliding with incoming air, fuel and steam mixture traveling in nozzle 20. At this very moment flow from nozzle 20 is interrupted and micro-packet 36 of an air, fuel, and steam mixture forms, and a pressure waves is generated. The air-fuel from micro-packets 36 are ignited by the hot iron cylinder 14 forming micro-explosions 38. The micro-explosions 38 generate electromagnetic, acoustic, and thermal energy. This results in a high negative pressure void or bubble being formed as the micro-explosions 38 expand. Micro-explosion 38 propels with high velocity contained particles which collide with other particles in the reaction zone and with the hot walls of the hot iron cylinder 14 and the walls of the reactor 16. As the micro-explosion 38 continues to expend and pushing on surrounding high pressure gases, the internal pressure of the expending micro-explosion 38 will continue to decrease by lowering the density of the gases caused by the increase in temperature and by the high velocity particles moving outward from the center of the micro-explosion 38. This forms a void or high negative pressure bubble. When the pressure of expending micro-explosion 38 equals the pressure of gases in the reaction chamber 16, then the bubble violently implodes and collapses to generate high pressure, high temperature plasma and a shock wave. A magnetic field is generated by the plasma currents. When the bubble collapses heated particles in the inner boundary surface of the bubble are accelerated towards the center of the collapsing bubble to fill the void where the particles collide to form plasma. At this moment matter contained in plasma been electrically conductive interact with eddy currents resulting in a further increase in temperature and pressure. Light fusible elements trapped inside the bubble are compressed under high pressure and temperature. The magnetic field generated by the plasma currents and the magnetic field generated by eddy currents may confine the plasma. At the end stage of collapsing bubble, fusible elements inside the bubble under high energy collision, high pressure, and temperature will fuse to form a heavier nucleus resulting in release of kinetic energy. The excess kinetic energy is stored in the degrees of freedom of moderator light water causing its temperature to rise. At thermal equilibrium water temperature is increased almost entirely by the thermo-kinetic-nuclear process. The mixture of water steam and combustion product exit the reactor chamber 16 through port 26 at a temperature near 1,000° C.

The Tomoiu thermo-kinetic process of the present invention was demonstrated with five prototype reactors that have been independently tested and operated with a mixture of: air, water and fuel simultaneously introduced at a reactor inlet port. Reported test data shows that the water-fuel ratio by mass was up to 16.45:1 and there was a continuous output of excess energy of up to 10.029 MJ/hr. The efficiency of the prototype reactors ranged from 125.2% to 180.66%.

While the present invention has been described with respect to several different embodiments, it will be obvious that various modifications may be made without departing from the spirit and scope of this invention.

What is claimed is:

1. A thermo-kinetic reactor with micro-nuclear implosions comprising:
a micro-packet and ultrasound generator having a nozzle and a resonance chamber with a conic-cylindrical geometry placed in a reaction chamber;
a passage formed between the nozzle and the resonance chamber of said micro-packet and ultrasound generator;
a coil placed in the reaction chamber having an input port for noncombustible fluid or water and an output port coupled to the nozzle;
the reaction chamber having an exhaust port and an iron cylinder placed inside the reaction chamber;
an induction coil wrapped around the reaction chamber having an induction coil input and an induction coil output port for water cooling; and
a thermal insulation chamber, whereby heat loss is minimized,
whereby the nozzle introduces a mixture of fuel and air and water steam from the coil,
whereby the mixture of fuel and air and water steam flow into the conic-cylindrical geometry of the resonance chamber to form a micro-packet and generate a pressure wave,
whereby the micro-packet ignites to form a micro-explosion in the reaction chamber and generating high frequency acoustic wave.

2. A thermo-kinetic reactor with micro-nuclear implosions as in claim 1 wherein:
said induction coil wrapped around the nozzle and resonance chamber is for direct heating; and
the nozzle and resonance chamber are made of materials with magnetic properties.

3. A thermo-kinetic reactor with micro-nuclear implosions which creates momentary micro-nuclear fusion reactors or MMNFR comprising the steps of:
forming a micro-packet of air, fuel, and water;
exploding the micro-packet of air, fuel and water mixture to form a micro-explosion;
forming a high negative pressure void or bubble in a center of micro-explosion;
wherein a high negative pressure bubble implosive collapses to form plasma and a confining magnetic field;
wherein high negative pressure bubble implosive collapses to generate a shock wave;
wherein fusible light elements trapped inside the bubble under high pressure and temperature fuse to form a heavier element with the release of kinetic energy;
wherein the fusible light elements are hydrogen isotopes; and
wherein kinetic energy is stored in the degrees of freedom of moderator light water causing its temperature to rise.

4. A method for generating micro-nuclear implosions comprising the steps of:
forming a micro-packet of air, fuel and water mixture;
exposing the air, fuel and, water micro-packets to electromagnetic, acoustic and thermal energy;
igniting the air-fuel mixture from the micro-packets to generate a micro-explosion;
forming a void or high negative pressure bubble in a center of the micro-explosion by lowering a density of gases caused by high temperature and moving outward with high velocities particles from the center of micro-explosion;
equalizing a micro-explosion pressure with reaction zone pressure;
collapsing the bubble where plasma and a confining magnetic field is formed;
fusing the light fusible elements trapped inside the bubble to form a heavier element and to generate kinetic energy; and
storing the kinetic energy in the degrees of freedom of moderator light water causing its temperature to rise.

5. A method to generate heat in a reaction zone using an iron cylinder electromagnetically coupled with an induction coil where air fuel mixture from a micro-packet auto ignite to generate electromagnetic, acoustic and thermal energy.

6. A method for generating a micro-explosion using an electrically conductive liquid mixed with air, and a fuel, comprising the steps of:
introducing an electrically conductive fluid or mixture of fluids in micro-packets and using a micro-packet generator to form micro-packets;
exposing the micro-packets to high frequency electromagnetic energy where eddy currents are formed in the electrically conductive fluid in the micro-packets causing its temperature to rise;
further exposing the micro-packets with the electrically conductive fluid to thermal, acoustic and electromagnetic energy where a micro-explosion is generated;
forming a void or bubble in the center of the micro-explosion; and
collapsing the bubble where fusible elements fuse to form a heavier element with the release of kinetic energy.

7. The method as in claim 6 comprising the further step of:
enriching the input of air, fuel, and light water with fusible elements comprising deuterium and tritium so as to increase efficiency.

8. A method of generating energy with a thermo-kinetic reactor comprising the steps of:
injecting a mixture of air, fuel, and steam at a nozzle pressure through a nozzle having an outlet placed adjacent a resonance chamber in a reaction chamber;
increasing a resonance chamber pressure in the resonance chamber greater than the nozzle pressure;
forming micro-packets of the mixture and generating a pressure wave;
igniting the micro-packets forming micro-explosions, whereby electromagnetic, acoustic, and thermal energy is generated;
creating a negative pressure bubble as the micro-explosions expand;
imploding and collapsing the negative pressure bubble, whereby particles comprising fusible elements in the negative pressure bubble accelerate towards a center of the negative pressure bubble generating a plasma and shock wave;
generating eddy currents in the plasma, whereby temperature and pressure are increased and the fusible elements are compressed; and
fusing the fusible elements forming a nucleus, whereby kinetic energy is released,
whereby energy is generated by said step of fusing of the fusible elements.
